(19) United States
(12) Patent Application Publication
(10) Pub. No.: US 2018/0085905 A1
(43) Pub. Date: Mar. 29, 2018

(54) COMPRESSION ENGINE FOR USE WITHIN A FASTENER-DRIVING TOOL UTILIZING A COMBUSTION CHAMBER TO MOVE A WORKING PISTON THROUGH ITS POWER STROKE AND A POWER ASSIST MECHANISM TO MOVE THE WORKING PISTON BACK THROUGH ITS COMPRESSION STROKE

(71) Applicant: Joseph S. Adams, Armstrong (CA)

(72) Inventor: Joseph S. Adams, Armstrong (CA)

(21) Appl. No.: 15/660,590

(22) Filed: Jul. 26, 2017

Related U.S. Application Data
(60) Provisional application No. 62/399,534, filed on Sep. 26, 2016.
(60) Provisional application No. 62/404,187, filed on Oct. 4, 2016.
(60) Provisional application No. 62/416,892, filed on Nov. 3, 2016.

(51) Int. Cl. B25C 1/08

(52) U.S. Cl. CPC B25C 1/08

(57) ABSTRACT

A compression engine for use within a gas fastener-driving tool for driving fasteners into workpieces comprises a first combustion chamber operatively associated with a working piston of the fastener-driving tool so as to move the working piston through its power stroke and thereby drive a fastener into a workpiece, and at least one power assist mechanism operatively associated with the working piston such that the power assist mechanism will effectively act upon the working piston in order to move the working piston from its disposition at the end of its power stroke back to its initial position and through a compression stroke at which time another fastener-driving operative cycle can be commenced. Preferably, the power assist mechanism comprises at least one other combustion chamber, or a rack and pinion mechanism. Ignition of the air/fuel mixtures within the various combustion chambers is controlled by an ignition module and the optimal control of various intake and exhaust valves within the various combustion chambers.

### FIELD OF THE INVENTION

The present invention relates generally to fastener-driving tools, and more particularly to a gas fastener-driving tool having a compression engine incorporated therein wherein a first combustion chamber is operatively or fluidically associated with a first surface portion of the working piston of the fastener-driving tool so as to move the working piston through its power stroke and thereby drive a fastener into a workpiece, and a power assist mechanism which is operatively associated with an undersurface, or second surface portion of the working piston that is not exposed to the first combustion chamber, such that the power assist mechanism will effectively cause the working piston to move from its disposition at the end of its power stroke back to its initial position and through a compression stroke in order to elevate the combustion pressure within the first combustion chamber, at which time another fastener-driving operative cycle can be commenced. Preferably, the power assist mechanism comprises a secondary combustion chamber, or alternatively, a rack and pinion mechanism. Ignition of the air/fuel mixtures within the various combustion chambers is controlled by an ignition module and the optimal control of various intake and exhaust valves within the various combustion chambers. The elevated combustion pressure within the first combustion chamber enables the tool to achieve enhanced combustion pressures, enhanced efficiency, enhanced output power, and improved cyclic operational times.

### BACKGROUND OF THE INVENTION

In a conventional dual combustion chamber engine for a fastener-driving tool, it is known to utilize a primary combustion chamber within which an air/fuel mixture is ignited, and a secondary combustion chamber which is separated from the primary combustion chamber by means of a wall having an opening defined therein and which is controlled by means of a check valve. Combustion, initiated within the primary combustion chamber, causes unburned fuel and air to be forced into the secondary combustion chamber thereby pressurizing an unburned air/fuel mixture within the secondary combustion chamber which is ignited as a result of a flame front passing from the primary combustion chamber into the secondary combustion chamber through means of the check valve. The resulting pressure is utilized to drive a working piston through a power stroke, in order to, for example, drive a fastener into a workpiece, with greater efficiency and at a greater pressure level than would otherwise be capable of attaining utilizing a single combustion chamber. While such efficiency and pressure levels are therefore an improvement over single combustion chamber tools, it is desirable to achieve still greater pressure levels, efficiency, and output power so as to, for example, be capable of driving fasteners into workpieces having larger thickness dimensions as well as increasing the number of fasteners that can be driven into a workpiece within a predetermined period of time.

It has been noted that while a dual combustion chamber engine for a fastener-driving tool exhibits a marked improvement in operational and performance characteristics relative to a single combustion chamber engine for a fastener-driving tool, the compression ratio, pressure level, and output power of such dual combustion chamber engines is still limited whereby, in turn, the fastener-driving tool has operational limitations. It is to be noted that it is well known that when an engine develops or is characterized by higher compression ratios, the resulting power output generated by the engine will be exponentially increased.

A need therefore exists in the art for a new and improved compression engine for use within a fastener-driving tool. An additional need exists in the art for a new and improved compression engine for use within a fastener-driving tool wherein the aforenoted improvements may be achieved relative to current state-of-the-art engines. Another need in the art exists for a new and improved compression engine for use within a fastener-driving tool wherein greater pressure levels can be achieved relative to current state-of-the-art engines. Yet another need in the art exists for a new and improved compression engine for use within a fastener-driving tool wherein greater compression ratios can be achieved relative to current state-of-the-art engines. Still another need in the art exists for a new and improved compression engine for use within a faster-driving tool wherein greater efficiency can be achieved relative to current state-of-the art engines. Yet still another need in the art exists for a new and improved compression engine for use within a faster-driving tool wherein greater output power levels can be achieved relative to current state-of-the-art engines whereby fasteners can be driven into workpieces having relatively larger thickness dimensions. A further need exists in the art for a new and improved compression engine for use within a fastener-driving tool wherein a greater number of fasteners can be driven into a workpiece within a predetermined period of time relative to current state-of-the-art engines.

### OVERALL OBJECTIVES OF THE INVENTION

An overall objective of the present invention is to provide a new and improved compression engine for use within a fastener-driving tool. An additional overall objective of the present invention is to provide a new and improved compression engine for use within a fastener-driving tool wherein the aforenoted improvements may be achieved relative to current state-of-the-art engines. Another overall objective of the present invention is to provide a new and improved compression engine for use within a fastener-driving tool wherein greater pressure levels can be achieved relative to current state-of-the-art engines. Yet another overall objective of the present invention is to provide a new and improved compression engine for use within a fastener-driving tool wherein greater compression ratios can be achieved relative to current state-of-the-art engines. Still another overall objective of the present invention is to provide a new and improved compression engine for use within a fastener-driving tool wherein greater efficiency can be achieved relative to current state-of-the-art engines. Yet still another overall objective of the present invention is to provide a new and improved compression engine for use within a fastener-driving tool wherein greater output power levels can be achieved relative to current state-of-the-art engines whereby fasteners can be driven into workpieces having relatively larger thickness dimensions. A further overall objective of the present invention is to provide a new and improved compression engine for use within a faster-driving tool wherein a greater number of fasteners can be driven into a workpiece within a predetermined period of time relative to cur-rent state-of-the-art engines.

### SUMMARY OF THE INVENTION

The foregoing and other objectives are achieved in accordance with the teachings and principles of the present invention through the provision of a new and improved compression engine for use within a gas fastener-driving tool wherein a first combustion chamber is operatively associated with a first surface portion of a working piston of the fastener-driving tool so as to move the working piston through its power stroke and thereby drive a fastener into a workpiece, and a power assist mechanism operatively associated with an undersurface, or second surface portion of the working piston that is not exposed to the first combustion chamber, such that the power assist mechanism will effectively act upon the working piston in order to move the working piston from its disposition at the end of its power stroke back to its initial position and through a compression stroke at which time another fastener-driving operative cycle can be commenced. Preferably, the power assist mechanism comprises a second combustion chamber, or a rack and pinion mechanism. Ignition of the air/fuel mixtures within the various combustion chambers is controlled by an ignition module and the optimal control of various intake and exhaust valves within the various combustion chambers.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a schematic view of a first embodiment of a new and improved gas fastener-driving tool, having a new and improved compression engine incorporated therein, for use in connection with the driving of fasteners into workpieces, and generally showing the various operative component parts thereof, at the completion of a fastener-driving cycle, wherein the component parts comprise first and second combustion chambers, and wherein, in particular, the working piston is shown disposed at its lowermost position or at a position corresponding to its disposition upon the completion of its power stroke as a result of combustion within the first combustion chamber, and during which power stroke, the working piston has driven a leading one of a serial arrangement of fasteners into a workpiece;

FIG. 2 is a schematic view similar to that of FIG. 1 showing, however, the first step of a new operational cycle wherein both intake and exhaust valves of both the first and second combustion chambers are disposed at their open positions so as to admit new or fresh air/fuel mixtures into both combustion chambers such that the air/fuel mixtures enter and flow through both combustion chambers so as to scavenge combustion products, generated during a previous combustion cycle, out through the exhaust valves of the combustion chambers;

FIG. 3 is a schematic view similar to those of FIGS. 1 and 2 showing, however, the second step of the operational cycle wherein the ignition module causes the spark ignitor disposed within the second combustion chamber to ignite the air/fuel mixture disposed within the second combustion chamber such that the air/fuel mixture disposed within the second combustion chamber is ignited whereby the resulting combustion pressure now acts upon undersurface portions of the head member of the working piston causing the working piston to be driven upwardly, or in the opposite direction with respect to its downward or other directional movement during its power stroke, toward the end of its compression stroke with substantially enhanced force so as to in turn substantially enhance the compression of the air/fuel mixture disposed within the first combustion chamber, and the compression ratio of the engine, it being noted that the intake and exhaust valves in both the first and second combustion chambers are closed, and when the working piston rod clears the serial array of fasteners, as sensed by the sensor disposed adjacent to the piston rod of the working piston, a new fastener has been moved into position beneath the piston rod or driver of the working piston in readiness for the next fastener-driving cycle;

FIG. 4 is a schematic view similar to that of FIG. 2 after the igniter has ignited the air/fuel mixture disposed within the first combustion chamber whereby the working piston has been moved through its power stroke, and wherein subsequent to the piston completing its power stroke, the intake and exhaust valves of both the first and second combustion chamber are once again opened such that the tool is again in position to commence a new operational cycle commencing with the scavenging of the combustion chambers as illustrated within FIG. 2 and the ignition of the air/fuel mixture within the second combustion chamber as illustrated within FIG. 3 so as to forcefully move the working piston back to its original START or elevated position within the first combustion chamber such that combustion of the air/fuel mixture within the first combustion chamber will again move the working piston through a new power stroke so as to drive a new leading fastener into the workpiece;

FIG. 5 is a schematic view generally similar to that of FIG. 1 showing, however, a second embodiment of a new and improved compression engine for use within a gas fastener-driving tool for driving fasteners into workpieces and generally showing the various operative component parts thereof which comprise a first combustion chamber and a second combustion chamber wherein, in lieu of the first and second combustion chambers being defined around longitudinal axes which are disposed substantially perpendicular to each other, as was the case with the first embodiment compression engine, the first and second combustion chambers of the second embodiment compression engine are defined around longitudinal axes that are disposed substantially parallel to one another;

FIG. 6 is a schematic view of the second embodiment compression engine which is similar to that shown in FIG. 2 in connection with the first embodiment compression engine in that the first step of a new operational cycle of the second embodiment compression engine is disclosed wherein both the intake and exhaust valves of both the first and second combustion chambers are disposed at their open positions, having been moved to such positions by means of a valve actuator, so as to admit new or fresh air/fuel mixtures into both combustion chambers such that the air/fuel mixtures enter and flow through both combustion chambers so as to scavenge combustion products, generated during a previous combustion cycle, out through the exhaust valves of the combustion chambers;

FIG. 7 is a schematic view of the second embodiment compression engine similar to that shown in FIG. 3 in connection with the first embodiment compression engine in that the second step of the operational cycle of the second embodiment compression engine is disclosed wherein the ignition module causes the spark igniter disposed within the second combustion chamber to ignite the air/fuel mixture disposed within the second combustion chamber whereby the air/fuel mixture disposed within the second combustion chamber is ignited such that the resulting combustion pressure now acts upon undersurface portions of the head member of the working piston causing the working piston to be driven upwardly, or in the opposite direction with respect to its downward or other directional movement during its power stroke, toward the end of its compression stroke with substantially enhanced force so as to in turn substantially enhance the compression of the air/fuel mixture disposed within the first combustion chamber, and the compression ratio of the compression engine, it being noted that the intake and exhaust valves in both the first and second combustion chambers have been moved to their closed positions by means of the aforenoted servo mechanism, and when the working piston rod clears the serial array of fasteners, as sensed by the sensor disposed adjacent to the piston rod of the working piston, a new fastener will be moved into position beneath the piston rod or driver of the working piston;

FIG. 8 is a schematic view similar to that shown in FIG. 7 wherein, however, there is illustrated the third step of the operational cycle of the second embodiment compression engine wherein the working piston has effectively obtained its uppermost position within the first combustion chamber, the ignition module causes the spark igniter disposed within the first combustion chamber to ignite the air/fuel mixture disposed within the first combustion chamber whereby the air/fuel mixture disposed within the first combustion chamber is ignited such that the resulting combustion pressure now acts upon the upper surface portion of the head member of the working piston causing the working piston to be driven downwardly or through its power stroke so as to drive a new leading fastener into the workpiece, it being noted that the intake and exhaust valves of the first combustion chamber are closed while the exhaust valve of the second combustion chamber is open;

FIG. 9 is a schematic view of the second embodiment compression engine which is similar to that shown in FIG. 6 wherein, again, both the intake and exhaust valves of both the first and second combustion chambers are disposed at their open positions, having been moved to such positions by means of the servo mechanism, so as to admit new or fresh air/fuel mixtures into both combustion chambers such that the air/fuel mixtures enter and flow through both combustion chambers so as to scavenge combustion products, generated during a previous combustion cycle, out through the exhaust valves of the combustion chambers;

FIG. 10 is a schematic view generally similar to that of FIG. 5 showing all of the component parts of the compression engine effectively returned to their original positions so as to be ready for a new fastener-driving operation to be initiated;

FIG. 11 is a schematic view similar to that of FIG. 1 showing, however, a third embodiment of a new and improved compression engine for use within a fastener-driving tool for driving of fasteners into workpieces, showing the various operative component parts thereof, and wherein, in particular, in addition to the use of the first and second combustion chambers, it is seen that this embodiment of the compression engine utilizes a fan, disposed within the second combustion chamber, so as to augment the flow and turbulence of the combustion products generated within the second combustion chamber and conducted toward the working piston such that the pressure of the combustion products generated within the second combustion chamber can act upon undersurface portions of the head portion of the working piston so as to in fact be utilized to drive the working piston upwardly or through its compression stroke within the cylinder within which the working piston is movable between its lowermost or end of power stroke position and its uppermost or end of compression stroke position;

FIG. 12 is a schematic view of a fourth embodiment of a new and improved compression engine for use within a gas fastener-driving tool for use in connection with the driving of fasteners into workpieces, showing the various operative component parts thereof, and wherein, in particular, only a main combustion chamber is operatively associated with the working piston, however, in lieu of the previously disclosed second combustion chamber effectively utilized as a power assist mechanism for enhancing the compression ratio and the compression of the air/fuel mixture within the main combustion chamber, the compression engine of the fifth embodiment utilizes an electric motor to drive a fan which provides inlet air into the main combustion chamber as well a rack and pinion or drive gear assembly operatively associated with the drive stem or piston rod of the working piston so as to move the working piston upwardly during its compression stroke, FIG. 12 showing the various components of the compression engine when the working piston has been moved to its lowermost or end of power stroke position and having completed the driving of a fastener into the workpiece, and wherein the air inlet and outlet ports of the main combustion chamber are open so as to permit air/fuel mixtures to flow therethrough in order to scavenge combustion products generated during the completed power stroke of the working piston;

FIG. 13 is a schematic view of the fourth embodiment gas fastener-driving tool as disclosed within FIG. 12 showing, however, the pinion or drive gear rotated in the counterclockwise direction so as to cause the rack component, integrally formed with or fixed upon the drive stem or piston rod of the working piston, to move upwardly thereby moving the drive stem or piston rod upwardly or through its compression stroke such that the head portion of the working piston is now disposed above the air inlet and outlet ports such that the main combustion chamber is effectively sealed whereby the air/fuel mixture disposed within the main combustion chamber begins to be compressed;

FIG. 14 is a schematic view of the fourth embodiment gas fastener-driving tool as disclosed within FIGS. 12 and 13 showing, however, the pinion or drive gear rotated still further in the counterclockwise direction so as to cause the rack component, integrally formed with or fixed upon the drive stem or piston rod of the working piston, to move upwardly still further through its compression stroke thereby moving the drive stem upwardly still further such that the head portion of the working piston is now disposed at its uppermost or end of compression position, it being noted that the pinion or drive gear has now also been disengaged from the rack defined upon the drive stem or piston rod of the working piston, the sensor has detected that the drive stem or piston rod of the working piston is now disposed at a predetermined elevated position so as to send a first signal to the ignition module so as to initiate combustion of the air/fuel mixture within the main combustion chamber as well as to send a second signal to the control mechanism, not shown, for incrementally advancing the fasteners such that a new fastener is disposed beneath the drive stem or piston rod of the working piston;

FIG. 15 is a schematic view of the fourth embodiment gas fastener-driving tool as disclosed within FIGS. 12-14 showing, however, the initiation of combustion within the main combustion chamber such that the working piston is now caused to move downwardly through its power stroke so as to in fact drive the leading fastener into the workpiece; and

FIG. 16 is a schematic view which is effectively the same as FIG. 12 in that the working piston is again disposed at its lowermost or end of power stroke position, having completed the driving of the leading fastener into the workpiece, wherein the air inlet and outlet ports of the main combustion chamber are again open so as to permit air/fuel mixtures to flow therethrough in order to scavenge combustion products generated during the completed operative cycle, however, the pinion or drive gear has not yet been rotated sufficiently enough in the counterclockwise direction so as to again engage the rack member defined upon the drive stem of the working piston so as to cause the working piston to begin to move upwardly in preparation for a subsequent compression stroke prior to the implementation of a new combustion operation within the main combustion chamber.

### DETAILED DESCRIPTION OF THE ILLUSTRATED EMBODIMENTS

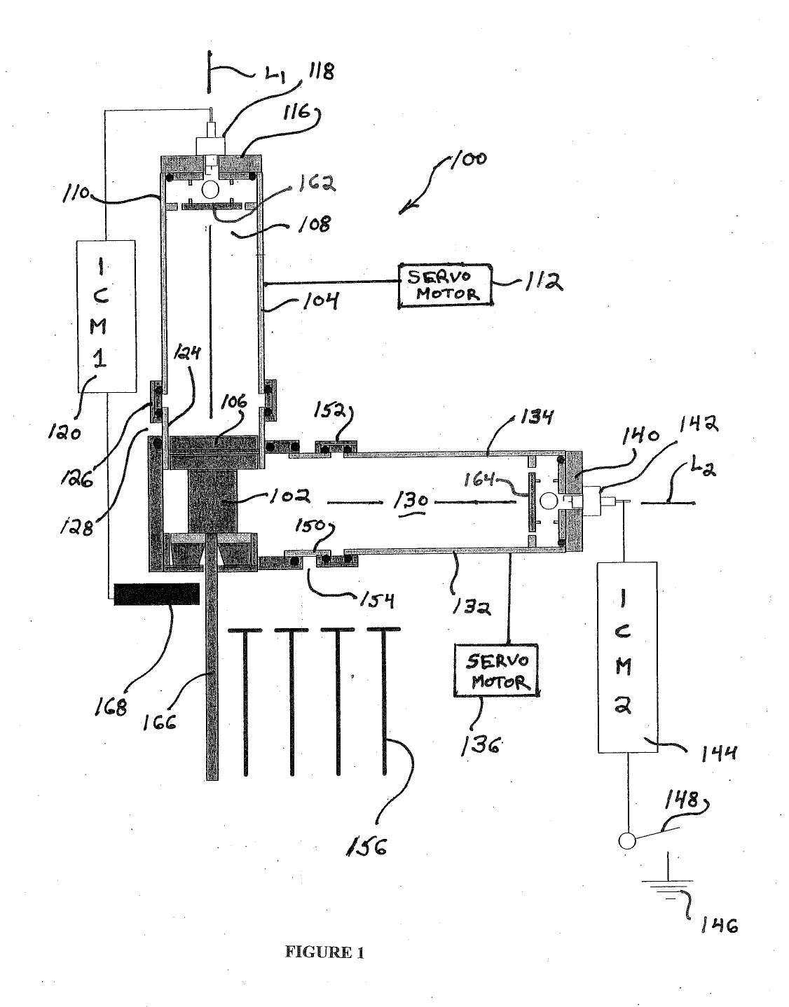

Referring now to the drawings, and more particularly to FIGS. 1-4 thereof, a first embodiment of a new and improved compression engine for use within a gas fastener-driving tool to be used for driving fasteners into workpieces, and as constructed in accordance with the principles and teachings of the present invention, is illustrated and is generally indicated by the reference character 100. As can best be seen in FIG. 1, the new and improved compression engine 100 is seen to comprise a working piston 102 which is disposed within a first cylindrical housing 104 so as to be movable between its lowermost position which occurs upon the completion of its power stroke, and it uppermost position which occurs upon completion of it compression stroke. While reference is made to upper and lower, or uppermost and lowermost, it is to be appreciated that such nomenclature only applies when the tool is disposed or oriented as shown in the drawings, however, the tool may be oriented in other orientations, such as, for example in an upside down orientation contrary to that shown in the drawings such as, for example, when the tool is being used to drive fasteners into an overhead workpiece such as a ceiling, or alternatively, when the tool is oriented horizontally as when the tool is being used to drive fasteners into a vertically oriented wall. Still further, while the working piston 102 will be referred to as moving in the upward or downward direction and toward its uppermost or lowermost position, it will be appreciated that the working piston 102 will be moving in a first direction toward its disposition at the completion of its power stroke, and in a second opposite direction toward its disposition at the completion of its compression stroke.

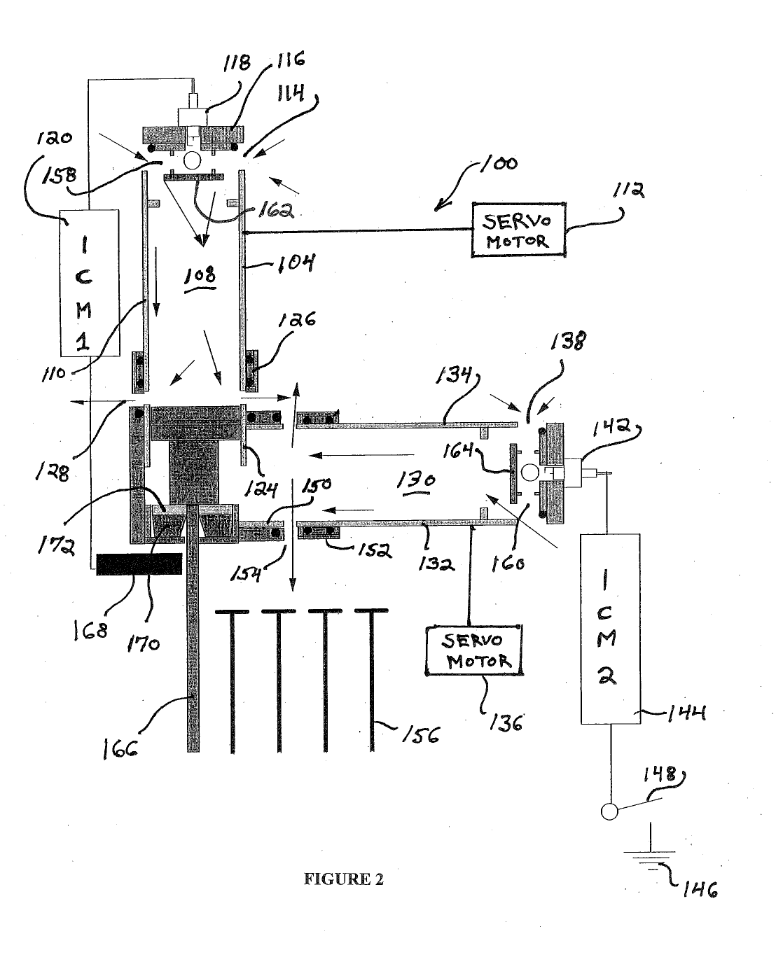

More particularly then, with reference still being made to FIG. 1, it is seen that the working piston 102 is movably disposed with-in the first cylindrical housing 104 along an axis L₁, and that above a head member 106 of the working piston 102, there is defined within the first cylindrical housing 104 a first combustion chamber 108. The first combustion chamber 108 is provided with a first air/fuel mixture intake valve 110 which is in the form of a sleeve valve that effectively forms the first cylindrical housing 104 and which is movable upwardly and downwardly, at appropriate operationally cyclic times by means of, for example, a first servo mechanism or motor 112 which thus controls the opening and closing of a first air/fuel mixture inlet port 114 which is defined between the upper end wall portion of the first cylindrical housing 104 and a first cap member 116 of the first combustion chamber 108 as can best be seen in FIG. 2. A first spark igniter 118 is fixedly mounted within the first cap member 116 of the first combustion chamber 108 so as to project into the upper end portion of the first combustion chamber 108 and is operatively connected to a first ignition control module 120 so as to initiate ignition of the air/fuel mixture disposed within the first combustion chamber 108. In a similar manner, it is noted that a second lower end portion of the first cylindrical housing 104 effectively forms a first combustion products exhaust valve 124 in view of the fact that it operatively cooperates with an annular valve block 126 which is fixedly mounted at a predetermined elevational location with respect to the lower outer peripheral surface portion of the first cylindrical housing 104. Accordingly, as can be seen in FIG. 1, when the valve sleeve 110 is disposed at its uppermost position, the combustion products exhaust valve 124 operatively cooperates with the annular valve block 126 whereby a combustion products exhaust valve port 128 is closed, whereas when the valve sleeve 110 is disposed at its lowermost position, as can best be seen in FIG. 2, the combustion products exhaust valve 124 operatively cooperates with the annular valve block 126 whereby the first combustion products exhaust valve port 128 is open.

Continuing further, a second combustion chamber 130 is disposed within a second cylindrical housing 132 which is oriented substantially perpendicular to the first cylindrical housing 104, as indicated by means of its longitudinal axis L₂, and which is operatively connected to a lower region of the first cylindrical housing 104. The second combustion chamber 118 is provided with a second air/fuel mixture intake valve 134 which is in the form of a sleeve valve, similar to the first air/fuel mixture intake valve 110 of the first combustion chamber 108, which effectively forms the second cylindrical housing 132 and which is movable laterally to the left and laterally to the right, at appropriate operationally cyclic times by means of, for example, a second servo mechanism or motor 136 which thus controls the opening and closing of a second air/fuel mixture inlet port 138 which is defined between the right end wall portion of the second cylindrical housing 132 and a cap member 140 of the second combustion chamber 130 as can also best be seen in FIG. 2. A second spark igniter 142 is also disposed within the second cap member 140 of the second combustion chamber 130 and is operatively connected to a second ignition control module 144 so as to initiate ignition of the air/fuel mixture disposed within the second combustion chamber 130. It is to be noted that the first and second ignition control modules 120,144 are operatively connected to a power source 146 by means of an electrical switch 148. In an additional manner similar to that of the first combustion chamber 108, it is noted that a second left end portion of the second cylindrical housing 132 effectively forms a second combustion products exhaust valve 150 in view of the fact that it operatively cooperates with an annular valve block 152 which is fixedly mounted at a predetermined lateral location with respect to the left outer peripheral surface portion of the second cylindrical housing 132. Accordingly, as can be seen in FIG. 2, when the valve sleeve 134 is disposed at its rightmost position, the combustion products exhaust valve 150 operatively cooperates with the annular valve block 152 whereby a combustion products exhaust valve port 154 is closed, whereas when the valve sleeve 134 is disposed at its leftmost position, as can best be seen in FIG. 2, the combustion products exhaust valve 150 operatively cooperates with the annular valve block 152 whereby the combustion products exhaust valve port 154 is open.

Having described substantially all of the operative components of the new and improved first embodiment compression engine 100, reference is again made to FIGS. 1-4 as a result of which the operation of the first embodiment of the new and improved compression engine 100, for use within a gas fastener-driving tool for driving fasteners into workpieces, will now be described. At the completion of a power stroke of the compression engine 100 whereby the leading fastener of a supply of fasteners 156 has been driven into the workpiece, the component parts of the first embodiment compression engine 100 will be disposed as illustrated within FIG. 1. More particularly, immediately upon completion of the power stroke of the compression engine 100, and as can best be appreciated from FIG. 2, the first and second servo mechanisms or motors 112,136 will be actuated so as to in turn move the first and second sleeve valves 110,134 such that the first and second sleeves valves 110,134 will be disposed at their open positions whereby the intake and exhaust valve ports 114,128,138,154 defined within the first and second combustion chambers 108,130 will be open. Accordingly, new or fresh air/fuel mixtures will flow into, through, and out from the first and second combustion chambers 108,130 such that the incoming/outgoing air/fuel mixtures will scavenge combustion products, generated during the previous combustion cycles within the first and secondary combustion chambers 108,130.

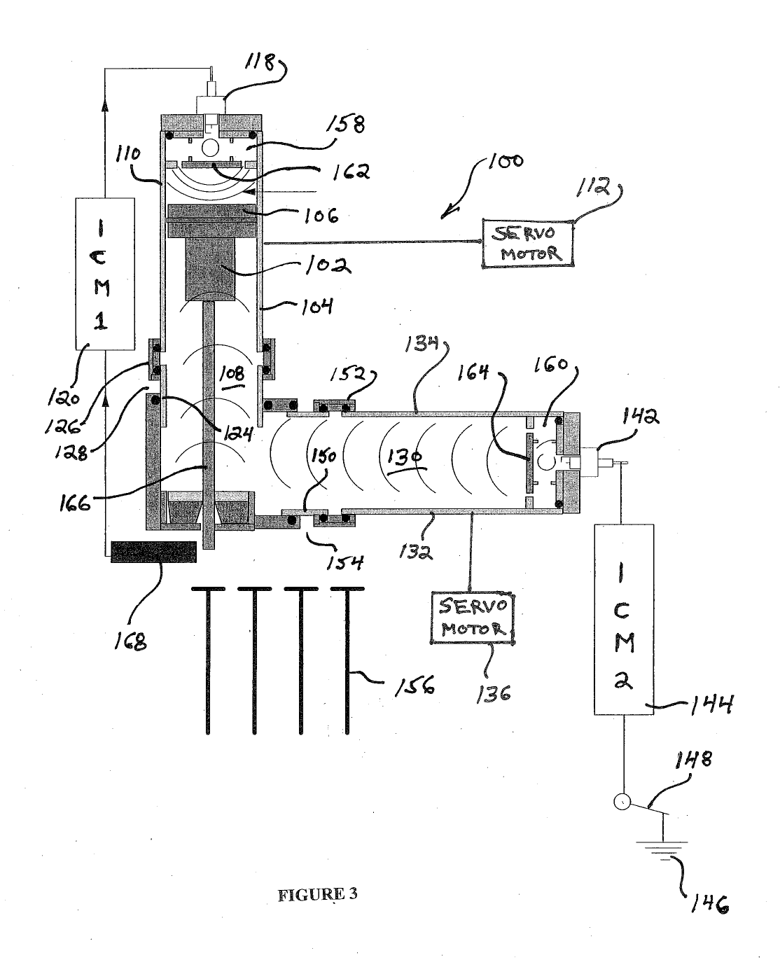

Subsequently, as can best be appreciated from FIG. 3, the first and second servo mechanisms or motors 112,136 will again be actuated, this time to effectively move the first and second sleeve valves 110,134 back to their original positions at which all of the intake and exhaust valve ports 114,128,138,154 will now be closed. In addition, the second ignition control module 144 will be actuated, as a result of the same being connected to the power source 146 through means of switch 148 which has been moved to its closed position, so as to transmit a signal to the second igniter 142 so as to ignite the air/fuel mixture disposed within the second combustion chamber 130. It is to be noted at this juncture that each one of the first and second combustion chambers 108,130 actually comprises a main combustion chamber and a pre-combustion chamber, or primary and secondary combustion chambers, the pre-combustion chambers of the first and second combustion chambers 108,130 being respectfully denoted by means of the reference characters 158,160, with suitable valve plates 162,164 operatively positioned between the pre-combustion chambers 158,160 and the first and second combustion chambers 108,130 so as to achieve combustion in a well known manner. An example of a combustion system comprising a pre-combustion chamber and a main combustion chamber, or primary and secondary combustion chambers, can be ascertained from U.S. Pat. No. 9,638,092 which issued to Adams on May 2, 2017.

With reference still being made to FIG. 3, it is seen that as a result of the combustion of the air/fuel mixture within the second combustion chamber 130, pressure forces developed by means of such combustion will act upon undersurface portions of the head member 106 of the working piston 102 whereby the working piston 102 will be forcefully moved upwardly within the cylinder 104 such that the head member 106 of the working piston 102 will now forcefully compress the air/fuel mixture disposed within the first combustion chamber 108 until the head member 106 of the working piston 102 substantially reaches the end of its compression stroke at which it fully compresses the air/fuel mixture disposed within the first combustion chamber 108 as illustrated within FIG. 3. At this point in time, it is noted that the lowermost end portion of the fastener driver or piston rod 166 has passed by a suitably positioned sensor 168 whereby a first signal is transmitted to a mechanism, not shown, which incrementally advances the serial array of fasteners 156 one step such that a new fastener is now coaxially disposed beneath the fastener driver or piston rod 166 of the working piston 102. In addition, a second signal is likewise transmitted from the sensor 168 to the first ignition control module 120 such that the first ignition control module 120 will, in turn, transmit a signal to the first igniter 118 disposed within the end cap 116 of the first combustion chamber 108 so as to ignite the air/fuel mixture disposed within the first combustion chamber 108.

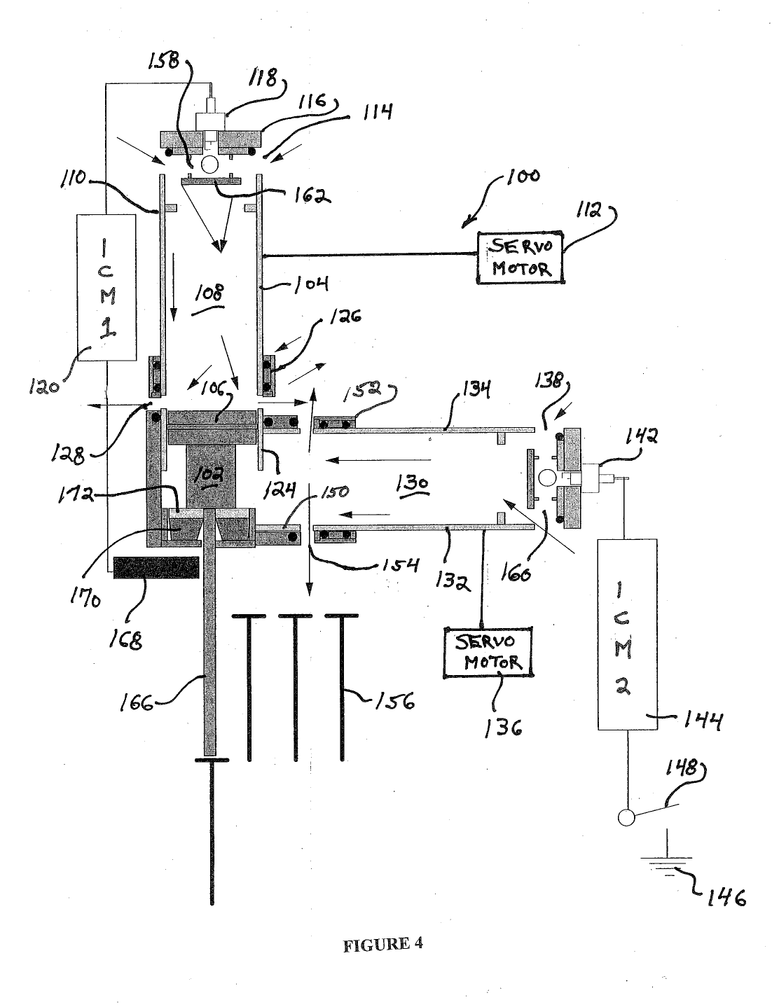

Accordingly, with all of the intake and exhaust valves 114,128,138, 154 of the first and second combustion chambers still disposed at their closed positions, and as a result of the first igniter 118 igniting the air/fuel mixture disposed within the first combustion chamber 108, the combustion of the air/fuel mixture disposed within the first combustion chamber 108 will force the working piston 102 to move downwardly and thereby undergo its power stroke, driving a fastener into a workpiece, until the working piston 102 has encountered a bumper 170 which is disposed within the bottom end portion of the cylinder 104. It is to be noted that the bumper 170 is fabricated from rubber or other similar material but is also effectively covered or protected by means of a heat shield 172 so as to protect the same from the heat and hot gases generated as a result of the combustion of the second air/fuel mixture within the second combustion chamber 130. It is additionally noted that while the working piston 102 is being moved downwardly through its power stroke, all residual air, air/fuel mixture, and combustion products from the second combustion chamber 130, and disposed beneath the head member 106 of the working piston 102, will have been forced back through the lower portion of the first cylinder 104 and into the second combustion chamber 130. This is the state of the tool as illustrated within FIG. 4, which is similar to that shown in FIG. 2 except for the additional disclosure of the leading fastener having been driven into the workpiece. Accordingly, immediately after the working piston 102 has attained its lowermost position at the end of its power stroke, the sensor 168 again transmits a signal to the first and second servo motors 112,136 whereby the first and second sleeve valves 110,134 are again moved to their open positions whereby all of the first and second intake and exhaust valves 114,138,128,154 of the first and second combustion chambers 108,130 are opened so as to permit new or fresh air/fuel mixtures to be conducted into, through, and exhausted out from the first and second combustion chamber 108,130 in order to scavenge the same in preparation for a new combustion and fastener-driving operational cycle of the tool.

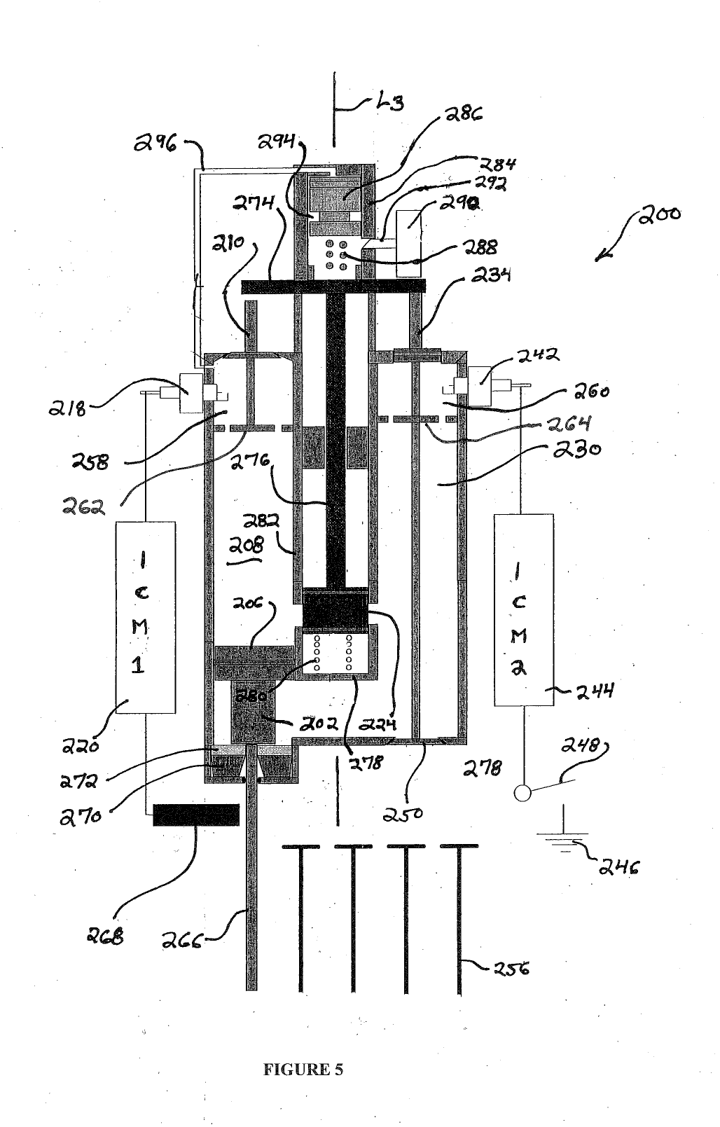

With reference now being made to FIGS. 5-9, a second embodiment of a new and improved compression engine for use within a gas fastener-driving tool for use in connection with the driving of fasteners into workpieces, and as constructed in accordance with the principles and teachings of the present invention, is illustrated and is generally indicated by the reference character 200. It is to be noted that component parts of the second embodiment compression engine 200 which are similar to components of the first embodiment compression engine 100 will be designated by corresponding reference numbers except that they will be within the 200 series. In addition, a detailed description of the second embodiment compression engine 200 will be omitted except for the necessary description thereof which effectively emphasizes how the second embodiment compression engine 200 differs from the first embodiment compression engine 100. More particularly, as illustrated within FIGS. 5-9, it can be seen, for example, that in lieu of the first and second combustion chambers 108,130 effectively being defined around longitudinal axes L₁,L₂ which are disposed substantially perpendicular to each other, the first and second combustion chambers 208,230 are effectively defined around longitudinal axes L₁,L₂ which are disposed substantially parallel to each other. It is also noted that the longitudinal axes L₁,L₂ of the first and second combustion chambers 208,230 are disposed upon opposite sides, or are radially spaced equally, from the central longitudinal axis L₃ of the entire compression engine 200. In addition, it is also noted that a significant difference between the second embodiment compression engine 200 and the first embodiment compression engine 100 resides in the structure and operationally sequential control of the intake and exhaust valves operatively associated with the first and second combustion chamber 208,230.

More particularly, with reference initially being made to FIG. 5, it is seen that the first combustion chamber 208 is provided with a first air/fuel mixture intake valve 210 while the second combustion chamber 230 is provided with a second air/fuel mixture intake valve 234. It is also seen that a transversely extending crosspiece or valve actuator 274 is integrally connected to the second combustion chamber intake valve 234, however, while operatively engageable with the first combustion chamber intake valve 210, as will be discussed hereinafter, the valve actuator 274 is not actually connected to the first combustion chamber intake valve 210 but is spaced a predetermined distance therefrom. The valve actuator 274 is provided with a longitudinally extending valve stem 276, and the lower end portion of the valve stem 276 is fixedly connected to a first exhaust valve 224 which is movable between open and closed positions so as to permit or prevent fluidic communication between the first combustion chamber 208 and the second combustion chamber 230. The first exhaust valve 224 is movable into and out from an exhaust valve housing 278 within which there is disposed a first biasing spring 280. In addition, the valve actuator 274 extends transversely through a cylindrical housing 282 within which the valve stem 276 is reciprocally movable in the vertical direction, and a cylindrical latching servo housing 284 is fixedly connected to the upper end portion of the cylindrical housing 282, with a latching servo 286 being reciprocally disposed within the servo housing 284. A second biasing spring 288 is interposed between the lower end of the latching servo 286 and the valve actuator 274, and a latch actuator 290 has a latching member 292 which is adapted to extend through an aperture defined within a side wall portion of the servo housing 284 so as to become engaged within a circumferential recess 294 defined within the outer peripheral surface of the latching servo 286. Lastly, a fluid feedback conduit 296 is fluidically connected between the first pre-combustion chamber 258 and the upper end portion of the servo housing 284 such that pressure from the first pre-combustion chamber 258 can act upon the upper surface portion of the latching servo 286 and against the biasing force of the second biasing spring 288.

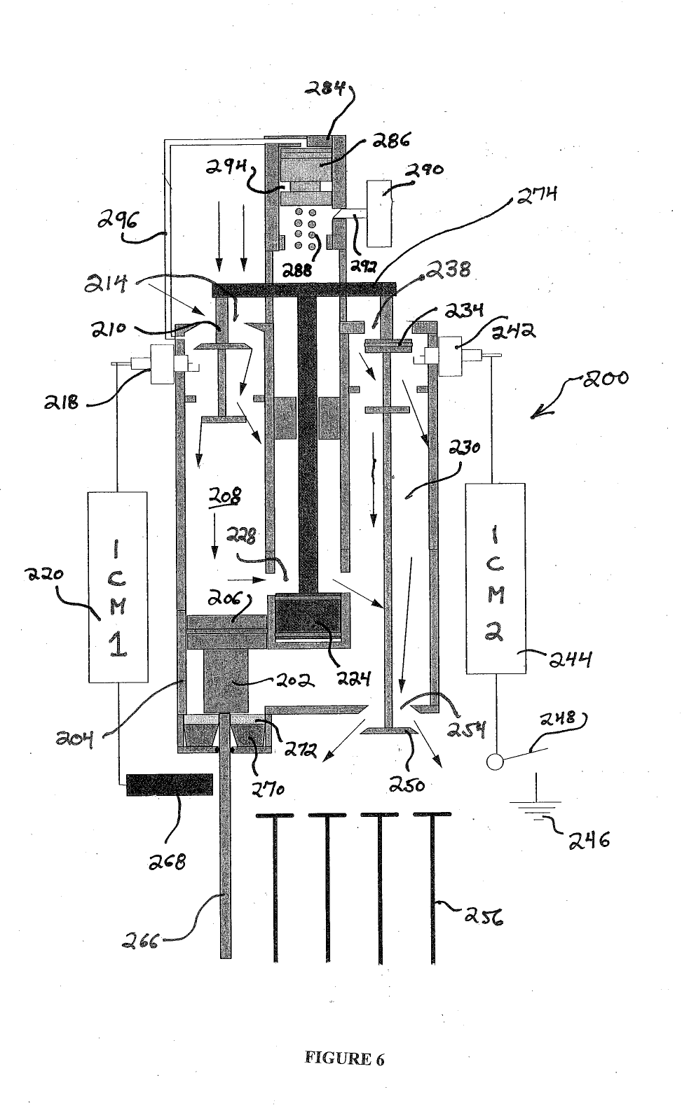

Having described substantially all of the operative components of the new and improved second embodiment compression engine 200, reference is now made specifically to FIGS. 5-10 as a result of which the operation of the second embodiment of the new and improved compression engine 200, for use within a gas fastener-driving tool for driving fasteners into workpieces, will now be described. At the completion of a power stroke of the compression engine 200 whereby the leading fastener of a supply of fasteners 256 has been driven into the workpiece, the component parts of the second embodiment compression engine 200 will be disposed as illustrated within FIG. 5 in preparation for the commencement of a new operational cycle. With reference therefore being made to FIG. 6, in order to initiate a new operational cycle wherein a new fastener can be driven into the workpiece, the valve actuator 274 will be moved downwardly, by any suitable means, not shown, such that, in turn, the valve stem 276 and the first combustion chamber exhaust valve 224 will likewise be moved downwardly against the biasing force of the first biasing spring 280 disposed within the exhaust valve housing 278. In this manner, the first combustion chamber exhaust valve 224 will be moved to its open position. Concomitantly, the downward movement of the valve actuator 274 causes the first combustion chamber intake valve 210 to be opened, as well as the second combustion chamber intake valve 234 to be opened, and since the second combustion exhaust valve 250 is integrally connected to the second combustion intake valve 234 as a result of being mounted upon the valve stem interconnecting the second combustion intake valve 234 and the second combustion exhaust valve 250, the second combustion exhaust valve 250 is likewise moved to its open position. Accordingly, all of the intake and exhaust valves 210,234,224,250 of both the first and second combustion chambers 208,230 are now open whereby fresh or new air/fuel mixtures can be conducted into, through, and exhausted out from the first and second combustion chambers 208,230 so as to scavenge any residual air, air/fuel mixtures, and combustion products that were generated during the previous combustion cycle.

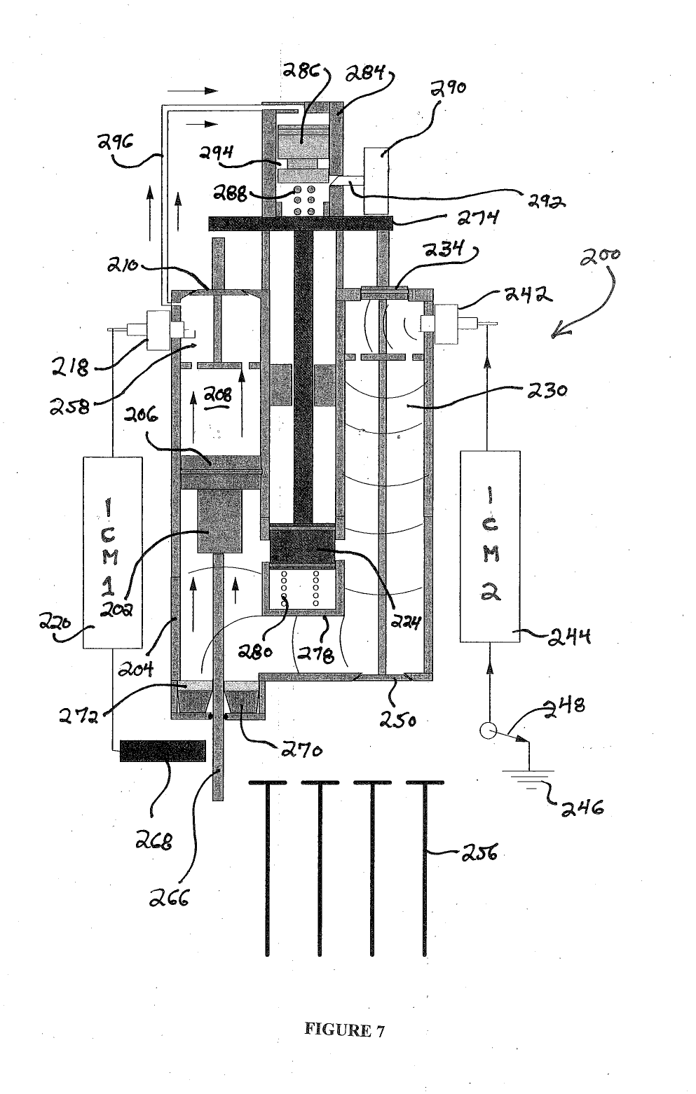

With reference therefore now being made to FIG. 7, once the scavenging of the first and second combustion chambers 208,230 has been completed, the valve actuator 274 is effectively released whereby all of the intake and exhaust valves 210,234,224,250 will be moved back toward their closed positions as originally illustrated within FIG. 5, or as now illustrated within FIG. 7, under the upward biasing force of the first biasing spring 280 disposed within the exhaust valve housing 278, although it is noted that the valve actuator 274 will actually be disposed slightly above the upper end portion of the valve stem of the first combustion chamber intake 210 for a purpose which will be discussed shortly hereinafter. The compression engine 200 is now ready to implement a new fastener-driving cycle. Accordingly, switch 248 is closed in connection with the power source 246 whereby the second ignition control module 244 now transmits a signal to the second ignition control module 144 so as to transmit a signal to the second igniter 242 so as to ignite the air/fuel mixture disposed within the second combustion chamber 230. As a result of the combustion of the air/fuel mixture within the second combustion chamber 230, pressure forces developed by means of such combustion will act upon undersurface portions of the head member 206 of the working piston 202 whereby the working piston 202 will be forcefully moved upwardly within the cylinder 204 such that the head member 206 of the working piston 202 will now forcefully compress the air/fuel mixture disposed within the first combustion chamber 208 until the head member 206 of the working piston 202 substantially reaches the end of its compression stroke at which it fully compresses the air/fuel mixture disposed within the first combustion chamber 208.

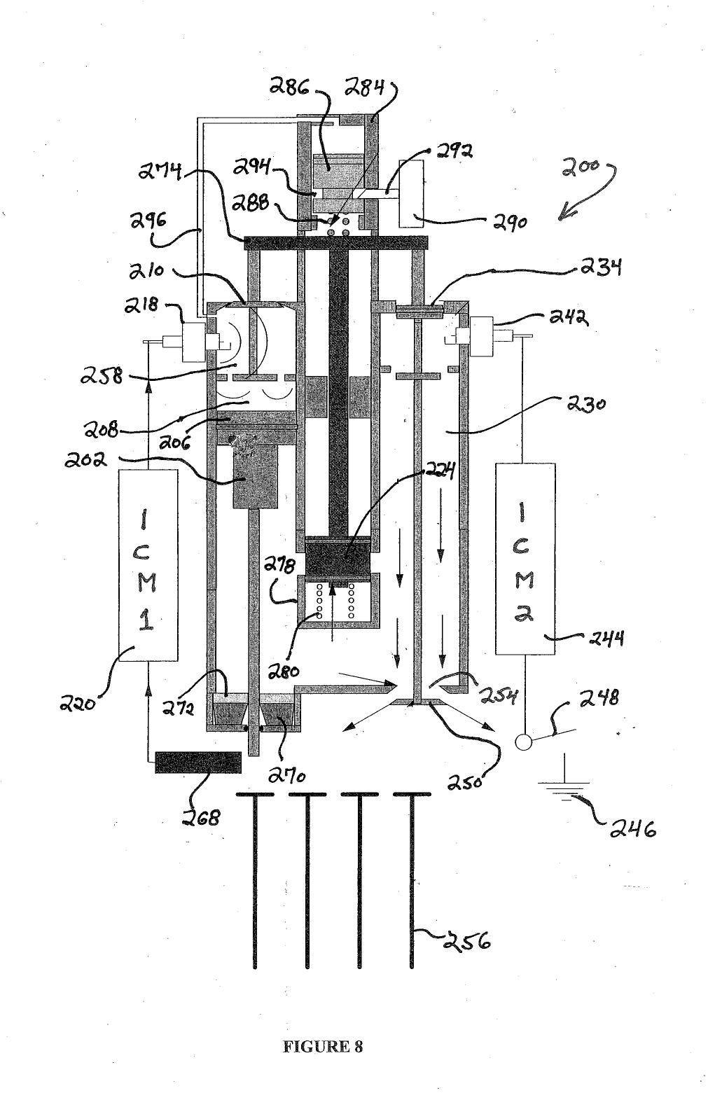

It is also noted that as a result of the upward movement of the working piston 202 within the first combustion chamber 208 and the consequential increased pressure developed within the first combustion chamber 208 as a result of the compression of the air/fuel mixture disposed within the first combustion chamber 208, fluid from the first pre-combustion chamber 258 is effectively transmitted as a fluidic signal to the interior portion of the servo housing 284 whereby such fluid acts upon the latching servo 286 so as to move the same slightly downwardly against the biasing force of the second biasing spring 288 disposed within the servo housing 284. Subsequently, as the working piston 202 continues its upward movement within the first combustion chamber 208 and attains its uppermost position which is effectively the end of its compression stroke, as illustrated within FIG. 8, while the lower end portion of the piston rod 266 passes the sensor 268, a first signal will be transmitted from the sensor 268 to the mechanism, not shown, which will incrementally advance the serial array of fasteners 256 one step such that a new fastener will be coaxially disposed beneath the fastener driver or piston rod 266 of the working piston 202. In addition, a second signal will be transmitted from the sensor 268 to the first ignition control module 220 such that the first ignition control module 220 will, in turn, transmit a signal to the first igniter 218 disposed within the first pre-combustion chamber 258 so as to ignite the air/fuel mixture disposed within the first pre-combustion chamber 258. Accordingly, with all of the intake and exhaust valves 214,228,238, 254 of the first and second combustion chambers 208.230 still disposed at their closed positions, and as a result of the first igniter 218 igniting the air/fuel mixture disposed within the first pre-combustion chamber 258, the combustion of the air/fuel mixture disposed within the first pre-combustion chamber 258 and the first combustion chamber 208 will force the working piston 202 to move downwardly and thereby undergo its power stroke, driving a fastener into a workpiece, until the working piston 202 has encountered the bumper 270 which is disposed within the bottom end portion of the cylinder 204.

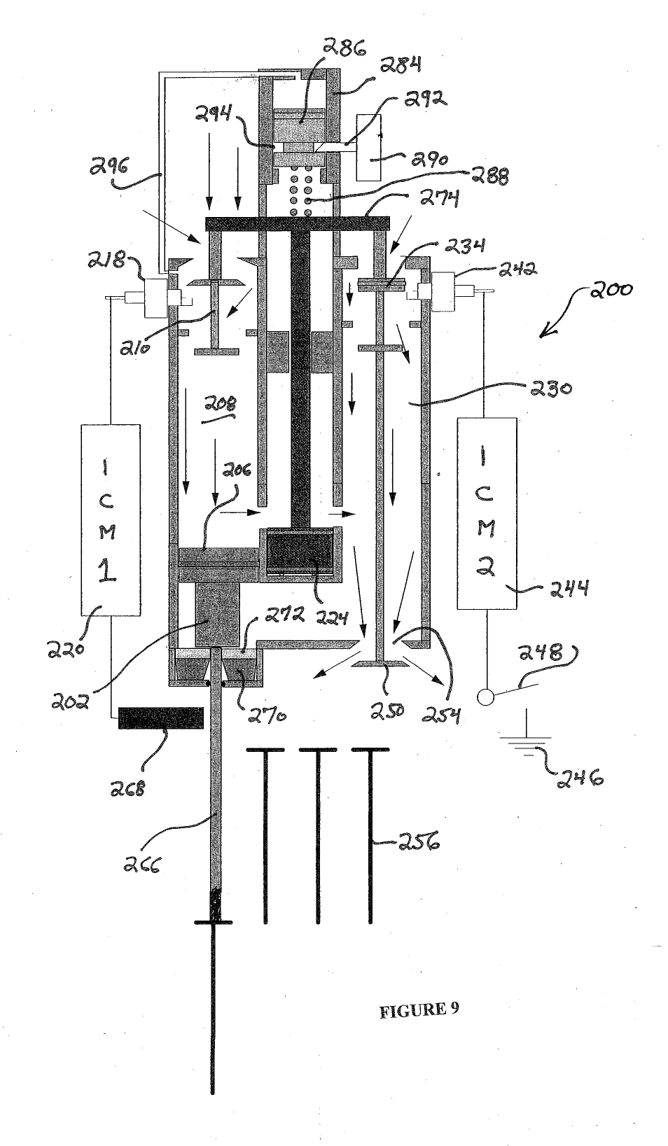

It is additionally noted that as a result of the increased pressure present within the first pre-combustion chamber 258 as a result of the ignition and combustion of the air/fuel mixture disposed within the first pre-combustion chamber 258, an enhanced fluidic signal is conducted toward and into the servo housing 284 by means of the fluid conduit 296. Accordingly, the latching servo 286 is caused to move downwardly against the biasing force of the second biasing spring 288, as well as against the biasing force of the first biasing spring 280 which is effectively pushing upwardly upon the first combustion chamber exhaust valve 224. This slight downward force impressed upon the second biasing spring 288 causes the second biasing spring 288 to force the valve actuator 274 to move slightly downwardly, and since the valve actuator 274 is fixedly connected to the second intake valve 234 operatively associated with the second combustion chamber 230, the second intake valve 234 will accordingly be moved slightly downwardly but not sufficiently to open the second intake valve 234. It is also noted that the valve actuator 274 has now engaged the upper end portion of the first combustion chamber intake valve 210. In addition, since the second intake valve 234 is integrally connected to the second exhaust valve 250, the second exhaust valve 250 will in fact be moved to its open position whereby residual air, air/fuel mixtures, and combustion products from the second combustion chamber 230, as well as from the space defined below the head portion 206 of the working piston 202, will be exhausted. At the same time that the latching servo 286 has been moved downwardly to its position illustrated within FIG. 8, the latch actuator 290 will actuate the latching member or mechanism 292 such that the latching member or mechanism 292 will engage the circumferential recess 294 defined within the outer peripheral wall portion of the latching servo 286, thereby fixing the latching servo 286 at its position illustrated within FIG. 8. Further combustion of the air/fuel mixture disposed within the first combustion chamber 208 will of course cause the working piston to move downwardly through its power stroke, thereby driving the leading fastener into the workpiece as illustrated within FIG. 9.

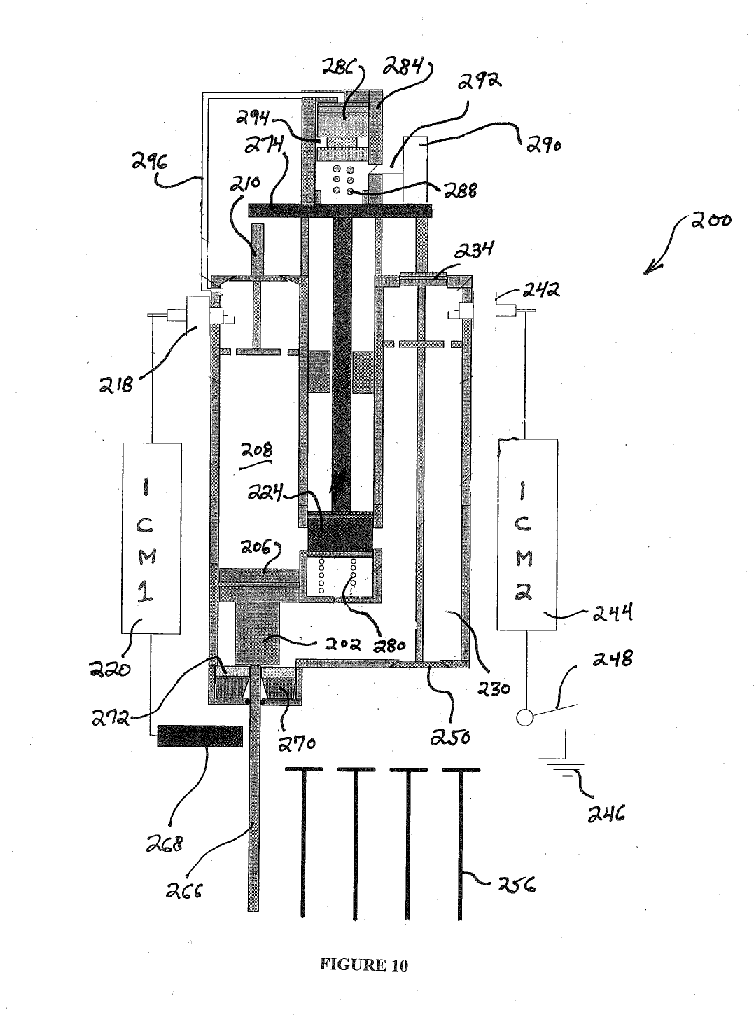

With reference therefore being made to FIG. 9, it will be clearly appreciated that the next operational step in the overall operational cycle is disclosed. More particularly, it is seen that the disposition of the various structural components of the compression engine 200 is somewhat similar to that illustrated within FIG. 6 with some notable exceptions. Upon completion of the power stroke of the working piston 202 and the driving of the lead fastener into the workpiece as illustrated in FIG. 9, the valve actuator 274 is once again actuated so as to effectively move the first and second intake valves 210,234 of the first and second combustion chambers 208,230 in the downward direction against the first biasing spring 280 thereby compressing the same within the first exhaust valve housing 278 and permitting the first and second intake valves 210,234 to be opened. Accordingly, not only will these movements also result in the opening of the first and second exhaust valves 224,250 whereby new or fresh air/fuel mixtures can now flow into, through, and out from the first and second combustion chambers 208,230 so as to scavenge residual air, air/fuel mixtures, and combustion products generated during the previous combustion cycle, but in addition, the downward movement of the valve actuator 274 and the compression of the first biasing spring 280 effectively relieves the pressure upon the second biasing spring 288 and, in turn, substantial pressure exerted upon the undersurface portion of the latching servo 286. Accordingly, after the first and second combustion chambers 208,230 have been completely scavenged and new or fresh air/fuel mixtures are present within the combustion chambers 208,230, the latch actuator 290 can now actuate the latch member or mechanism 292 so as to effectively retract the latch member or latch mechanism 292 from its disposition within the circumferential recess 294 defined within the latching servo 286 as illustrated within FIG. 10. Accordingly, all component parts of the compression engine 200 have now regained their original positions as illustrated within FIG. 5 whereby the compression engine 200, and the fastener-driving tool, are ready for a new fastener-driving operation.

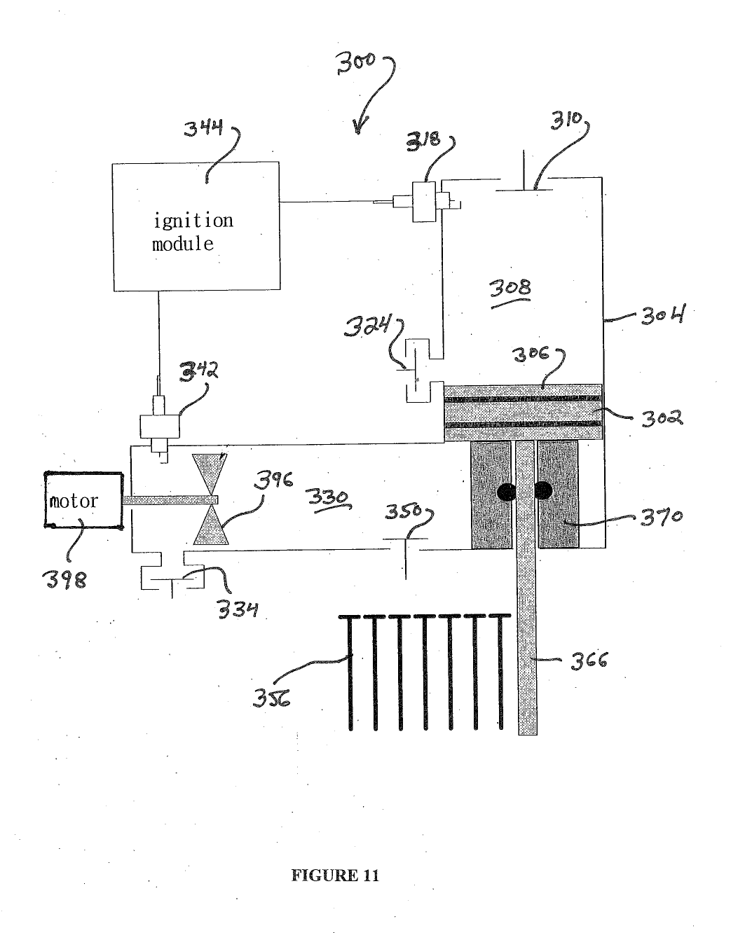

With reference now being made to FIG. 11, a third embodiment of a new and improved compression engine fore use within a gas fastener-driving tool for use in connection with the driving of fasteners into workpieces, and as constructed in accordance with the principles and teachings of the present invention, is illustrated and is generally indicated by the reference number 300. It is to be noted that component parts of the third embodiment compression engine 300 which are similar to components of the first and second embodiment compression engines 100 and 200 will be designated by corresponding reference numbers except that they will be within the 300 series. In addition, it is to be noted that the description of the third embodiment compression engine 300 will emphasize the structural differences between the third embodiment compression engine 300 and the first and second embodiment compression engines 100,200. More particularly, as can be seen in FIG. 11, it is to be appreciated that the third embodiment compression engine 300 is somewhat similar to the first embodiment compression engine 100 in that the compression engine 300 comprises first and second combustion chambers 308,330 which are disposed substantially perpendicular to each other, however, it is also noted that a fan 396, driven by means of a suitable motor 398, is disposed within the second combustion chamber 330 so as to augment the flow of combustion products toward the working piston 302 such that the pressure of the combustion products can act upon undersurface portions of the head portion 306 of the working piston 302 so as to in fact be utilized to drive the working piston 302 upwardly within the cylinder 304 within which the working piston 302 is movable between its lowermost or end of power stroke position and its uppermost or end of compression stroke position. It is lastly noted that another difference between the compression engine 300 and the compression engines 100 and 200 resides in the fact that in the compression engine 300, a single ignition control module 344 is utilized to timely control both of the first and second igniters 318 and 342. The operational cycle of the third embodiment compression engine 300 is substantially the same as the operational cycles of the first and second embodiment compression engines as respectively illustrated within FIGS. 1-4 and FIGS. 5-10.

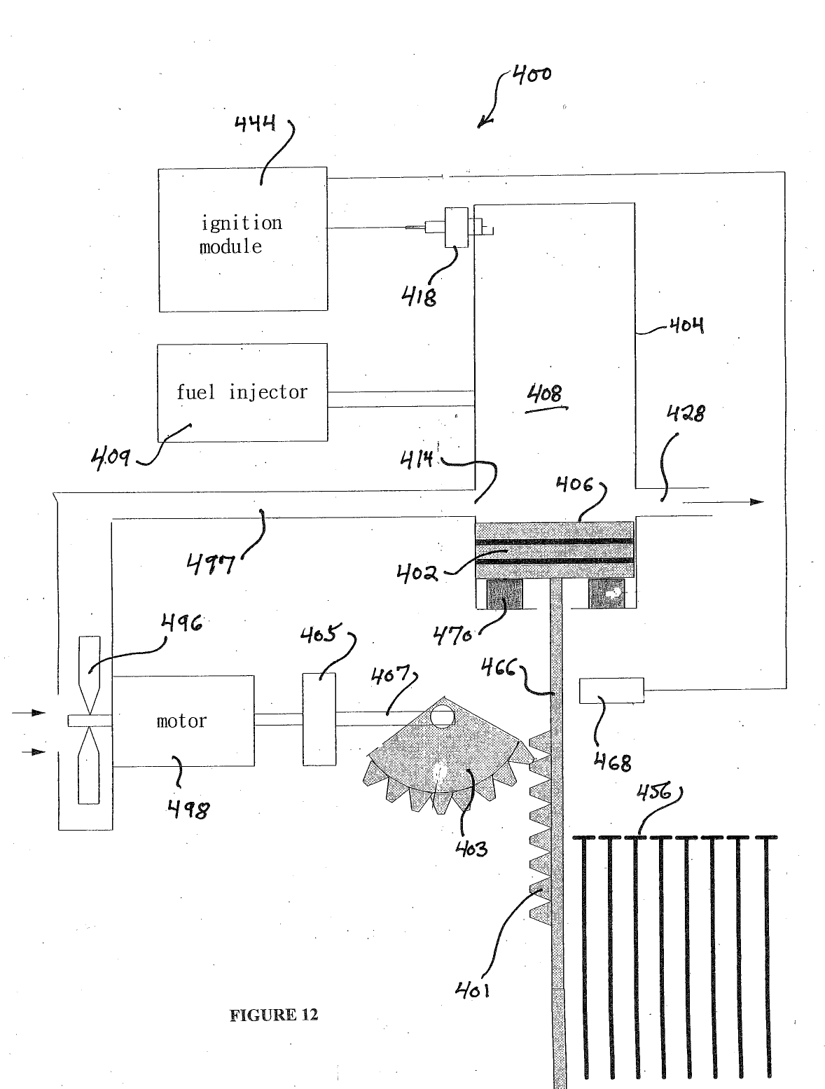

With reference lastly being made to FIGS. 12-16, a new and improved fourth embodiment compression engine for use in connection with a gas fastener-driving tool for use in connection with the driving of fasteners into workpieces, and as constructed in accordance with the principles and teachings of the present invention, is illustrated and is generally indicated by the reference number 400. It is to be noted that component parts of the fourth embodiment compression engine 400 which are similar to component parts of the first, second, and third embodiment compression engines 100,200,300 will be designated by corresponding reference numbers except that they will be within the 400 series. In addition, as was the case with the second and third embodiment compression engines 200,300, the description of the fourth embodiment compression engine 400 will effectively concentrate upon the differences between the fourth embodiment compression engine as compared to the first, second, and third compression engines 100,200,300.

More particularly, with reference first being made to FIG. 12, it is seen that the fourth embodiment compression engine only comprises a main, first, or primary combustion chamber 408 which is operatively associated with a working piston 402, and in lieu of the previously disclosed second combustion chamber as respectively disclosed, for example, within the previous compression engines 100, 200,300, the compression engine 400 of the fourth embodiment utilizes an electric drive motor 498 to drive a fan 496 which causes ambient air to flow through an intake air supply conduit 497 into the main combustion chamber 408 through means of an air inlet port 414 defined within a first side wall portion of the cylinder 404, while an air outlet port 428 is defined within a second oppositely disposed side wall portion of the cylinder 404, whereby the air flow flows directly from the air inlet port 414, through the bottom portion of the main combustion chamber 408, and out through the outlet port 428 so as to scavenge combustion products generated during the previous combustion cycle. The fourth embodiment compression engine 400 is also seen to comprise a rack and pinion or drive gear assembly comprising a rack 401 which is operatively associated with the piston rod or fastener driver 466 of the working piston 402, as a result of being integrally formed with or fixed upon the piston rod or fastener driver 466 of the working piston 402, so as to move the working piston 402 upwardly during its compression stroke so as to enhance the compression of the air/fuel mixture disposed within the main combustion chamber 408, and a pinion or drive gear 403 which is adapted to be rotationally engaged with and disengaged from the rack 401 as a result of the counterclockwise rotational movement of the pinion or drive gear 403 through means of a suitable transmission 405 and a tie rod 407 operatively connecting the pinion or drive gear 403 to the transmission 405 as well as the transmission 405 being connected to the drive motor 498.

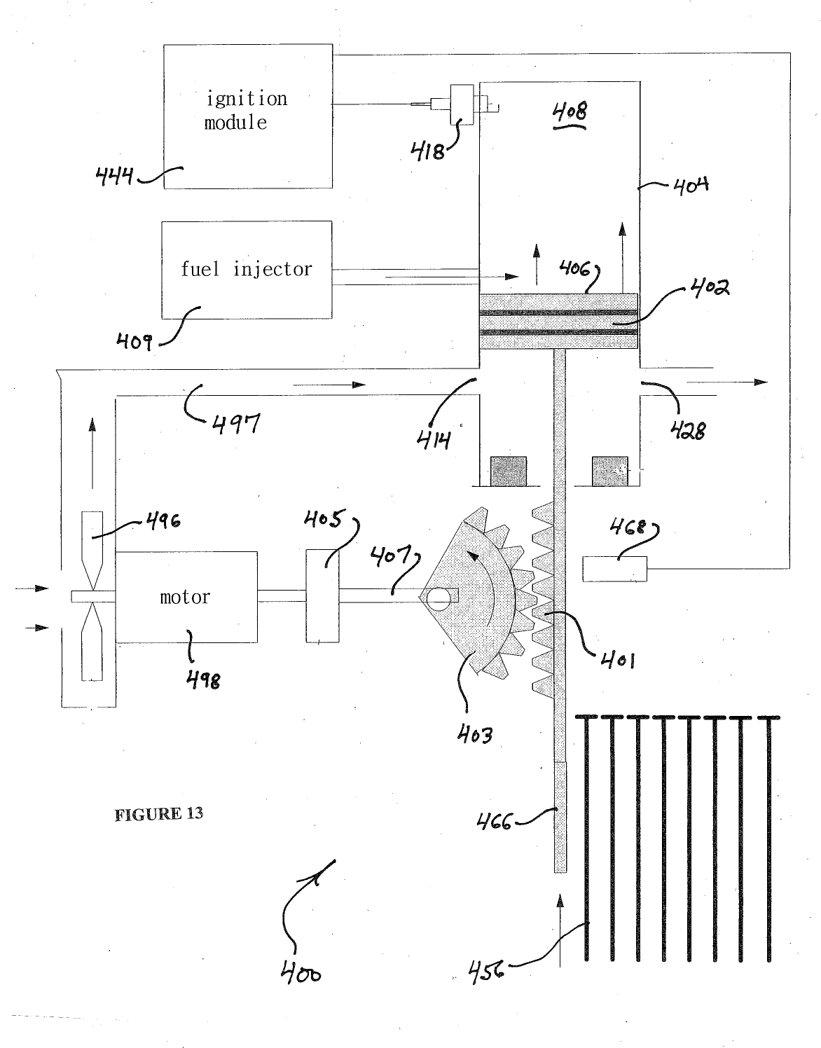

As illustrated within FIG. 12, the working piston 402 is disposed at its lowermost position at which time the pinion or drive gear 403 has been rotated to a position at which the pinion or drive gear 403 is just about to engage the rack 401 disposed upon the piston rod or driver 466 of the working piston 402. Continuing further, and as illustrated within FIG. 13, the pinion or drive gear 403 has now been rotated further in the counterclockwise direction and is now fully engaged with the rack 401 formed upon the piston rod or driver 466 of the working piston 402 whereby the working piston 402 is now elevated to a position at which the head member 406 of the working piston 402 is now disposed at an elevational level that is above the air inlet and air outlet ports 414,428 defined within the side wall portions of the cylinder 404. Accordingly, the main combustion chamber 408 is now effectively sealed, during which time fuel is injected into the main combustion chamber 408 by means of a fuel injector 409 whereby the continued upward movement of the working piston 402, as power-assisted by means of the rack and pinion mechanism 401,403 serves to compress the air/fuel mixture disposed within the main combustion chamber 408. Still further counterclockwise rotation of the pinion or drive gear 403 elevates the working piston 402 still further until the working piston 402 attains its uppermost position within the main combustion chamber 408 at which time the sensor 468 will transmit a signal to the ignition module 444 which, in turn, transmits a signal to the igniter 418 so as to ignite the air/fuel mixture disposed within the main combustion chamber 408.

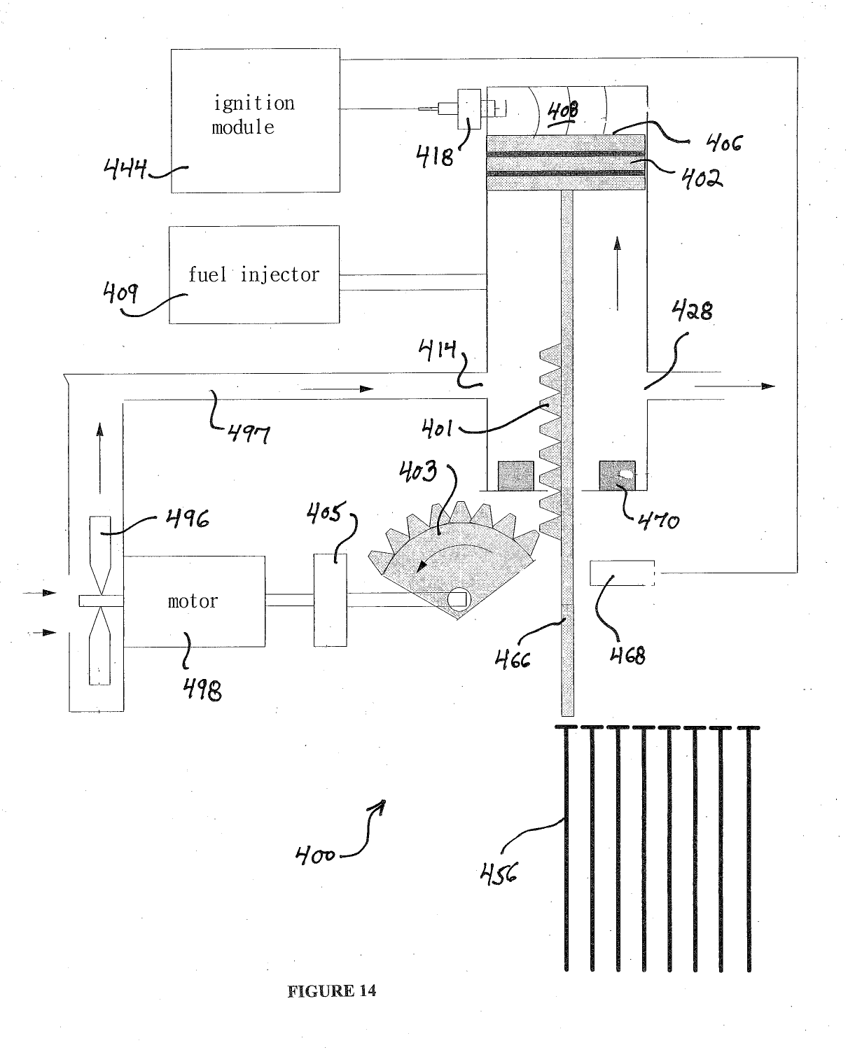

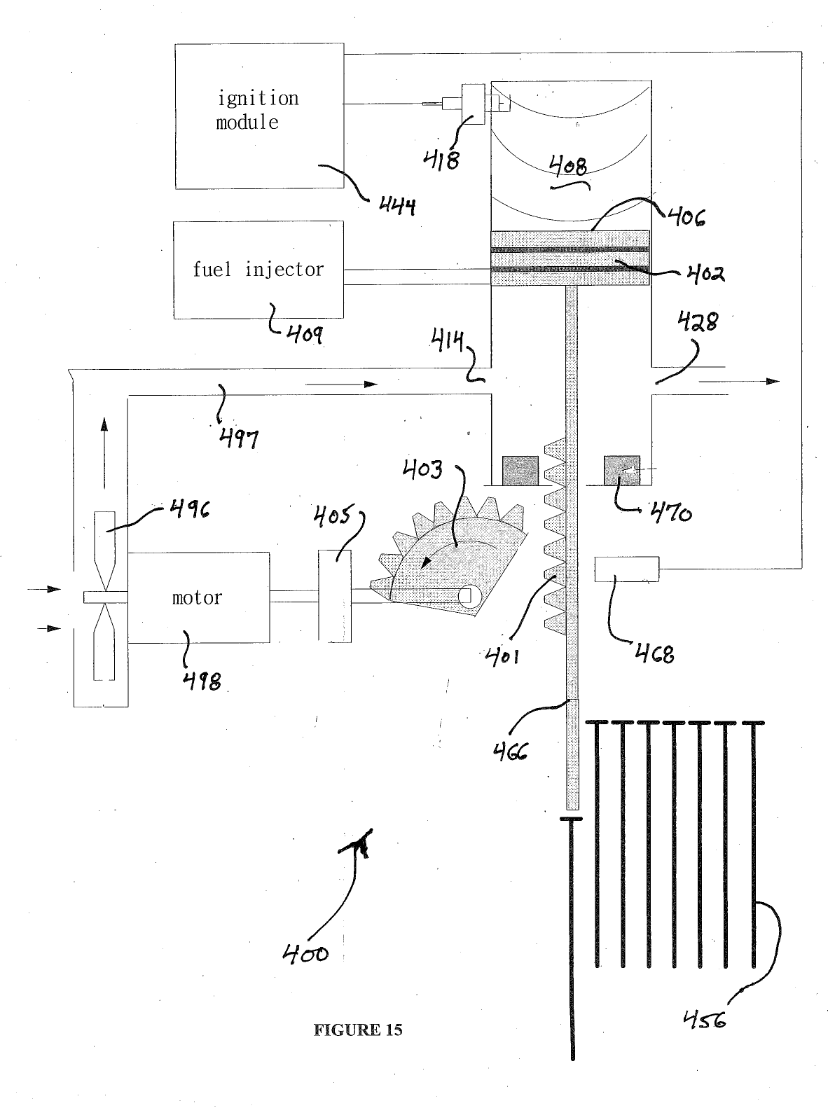

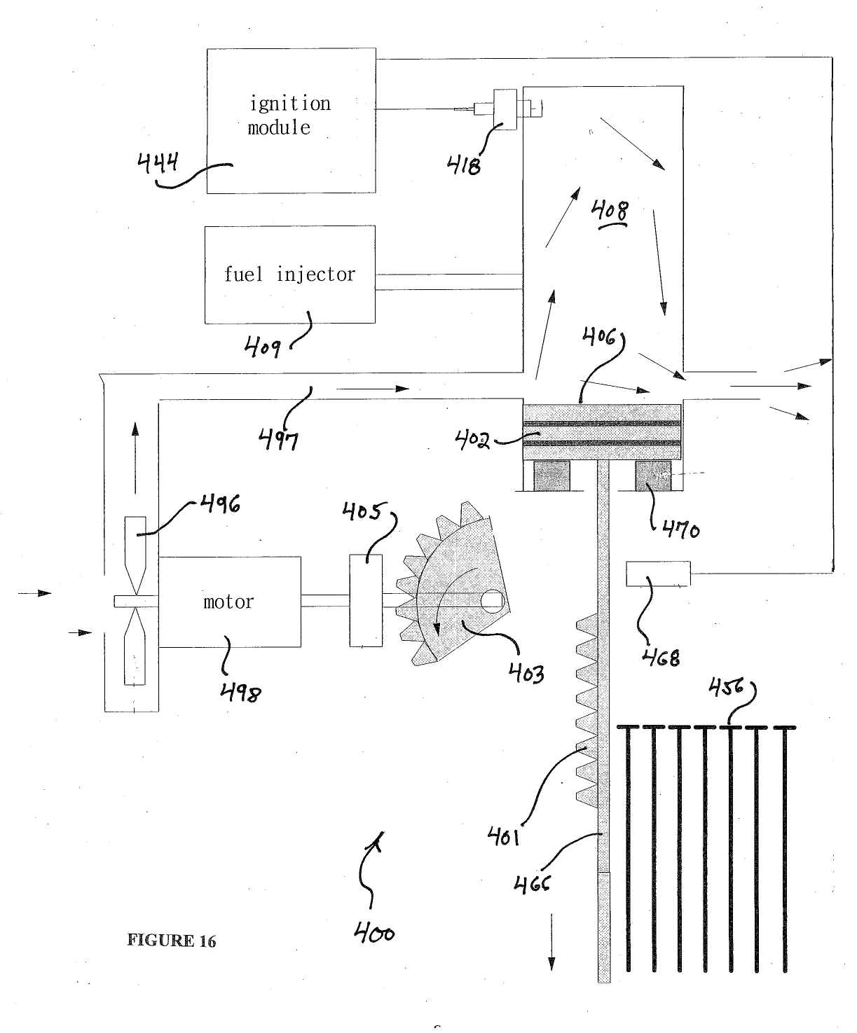

It is to be noted that at this time, the pinion or drive gear 403 has been disengaged from the rack 401, and that the sensor 468 has also transmitted a signal to the control mechanism which incrementally moves a new fastener 456 into position below the piston rod or driver 466 of the working piston 402, all as illustrated within FIG. 14. As a result of the combustion of the air/fuel mixture disposed within the main combustion chamber 408, the working piston 402 is now moved downwardly so as to drive the new leading fastener 456 into the workpiece, and the motor 498 and the transmission 405 continue to rotate the pinion or drive gear 403 in the counterclockwise direction, all as illustrated within FIG. 15. When the working piston 502 has attained its lowermost position as illustrated within FIG. 16, the leading fastener 546 has been driven into the workpiece and the component parts of the fourth embodiment compression engine 400 have effectively attained their original positions as illustrated within FIG. 12 except for the fact that the pinion or drive gear 403 has not as yet been fully rotated so as to begin to again engage the rack 401 of the piston rod or driver 466 of the working piston 402. Nevertheless, the head member 406 of the working piston 402 is once again disposed at an elevational level which is beneath that of the air inlet and air outlet ports 414, 428 such that air can once again flow from the air inlet port 414, through the main combustion chamber 408, and out from the air outlet port 428 so as to scavenge the combustion products disposed and generated within the main combustion chamber 408 during the previously completed combustion cycle. Accordingly, the various component parts of the fourth embodiment compression engine 400 are again disposed at their respective positions as illustrated within FIG. 12 whereby the fastener-driving tool is ready to undergo a new fastener-driving operational cycle.

Obviously, many variations and modifications of the present invention are possible in light of the above teachings. It is therefore to be understood that within the scope of the appended claims, the present invention may be practiced otherwise than as specifically described herein.

### REFERENCE NUMBER KEY

100—First embodiment compression engine
102—Working piston
104—Engine cylinder
106—Head portion of working piston 102
108—First combustion chamber
110—First intake sleeve valve
112—First servo motor for sleeve valve 110
114—First air/fuel mixture inlet port
116—Upper end cap of first combustion chamber 108
118—First igniter within first combustion chamber 108
120—First ignition control module
124—First exhaust valve of first combustion chamber 108
126—First valve block of first combustion chamber 108
128—First exhaust port of first combustion chamber 108
130—Second combustion chamber
132—Cylinder of second combustion chamber
134—Second intake sleeve valve
136—Servo motor for sleeve valve 134
138—Second air/fuel mixture intake port of second combustion chamber 130
140—End cap of second combustion chamber 130
142—Second igniter of second combustion chamber 130
144—Second ignition control module
146—Power source
148—Switch for connecting ignition control modules to power source 146
150—Second exhaust valve of second combustion chamber 130
152—Second valve block of second combustion chamber 130
154—Second exhaust port of second combustion chamber 130
156—Serial array of fasteners to be driven into workpiece
158—Pre-combustion chamber of first combustion chamber 108
160—Pre-combustion chamber of second combustion chamber 130
162—First valve plate of first combustion chamber 108
164—Second valve plate of second combustion chamber 108
166—Piston rod/fastener driver
168—Sensor
170—Bumper
172—Heat shield for bumper 170
L₁—Longitudinal axis of first combustion chamber
L₂—Longitudinal axis of second combustion chamber
200—Second embodiment compression engine
202—Working piston
204—Engine cylinder
206—Head portion of working piston 202
208—First combustion chamber
210—First intake valve
214—First air/fuel mixture inlet port
218—First igniter within first combustion chamber 208
220—First ignition control module
224—First exhaust valve of first combustion chamber 208
228—First exhaust port of first combustion chamber 208
230—Second combustion chamber
234—Second intake valve of second combustion chamber 230
238—Second air/fuel mixture intake port of second combustion chamber 230
242—Second igniter of second combustion chamber 230
244—Second ignition control module
246—Power source
248—Switch for connecting ignition control modules to power source 246
250—Second exhaust valve of second combustion chamber 230
254—Second exhaust port of second combustion chamber 230
256—Serial array of fasteners to be driven into workpiece
258—Pre-combustion chamber of first combustion chamber 208
260—Pre-combustion chamber of second combustion chamber 230
262—First valve plate of first combustion chamber 208
264—Second valve plate of second combustion chamber 208
266—Piston rod/fastener driver
268—Sensor
270—Bumper
272—Heat shield for bumper 270
274—Valve actuator
276—Valve actuator stem
278—Housing for first exhaust valve 224
280—First biasing spring
282—Cylindrical housing
284—Servo housing
286—Latching servo
288—Second biasing spring
290—Latch actuator
292—Latch member
294—Circumferential recess of 284
296—Fluid signal line
L₁—Longitudinal axis of first combustion chamber
L₂—Longitudinal axis of second combustion chamber
L₃—Longitudinal axis of compression engine
300—Third embodiment compression engine
302—Working piston
304—Cylinder of 300
306—Piston head
308—First combustion chamber
310—First intake valve of first combustion chamber 308
318—First igniter for first combustion chamber 308
324—First exhaust valve of first combustion chamber
330—Second combustion chamber
334—Second intake valve for second combustion chamber 330
342—Second igniter for second combustion chamber 330
344—Ignition module
350—Second exhaust valve for second combustion chamber 330
356—Array of fasteners
366—Piston rod/fastener driver
370—Bumper
396—Fan within second combustion chamber 330
398—Motor for fan 396
400—Fourth embodiment compression engine
401—Gear rack formed upon piston rod/fastener driver 466
402—Working piston
403—Gear pinion
404—Cylinder of compression engine
405—Transmission connecting motor 498 to gear pinion
406—Piston head
407—Tie rod connecting transmission 405 to gear pinion
408—Combustion chamber
409—Fuel injector
414—Air inlet port
418—Igniter within combustion chamber 408
428—Air outlet port
444—Ignition module
456—Array of fasteners
466—Piston rod/fastener driver
468—Sensor
470—Bumper
496—Fan
497—Fluid conduit for conducting air flow from fan 496 to air inlet port 414
498—Motor for fan 496

What is claimed as new and desired to be protected by Letters Patent, is:

1. A compression engine for a gas fastener-driving tool for driving fasteners into workpieces, comprising:
a working piston;
a first combustion chamber operatively associated with said working piston and containing an air/fuel mixture such that when the air/fuel mixture is ignited within said first combustion chamber, said working piston will be forced through a power stroke in order to drive a fastener into a workpiece; and
a power assist mechanism operatively associated with said working piston for moving said working piston through a return compression stroke so as to enhance the compression of an air/fuel mixture disposed within said first combustion chamber, and the compression ratio of said compression engine, in preparation for the ignition of an air/fuel mixture disposed within said first combustion chamber whereupon ignition of the air/fuel mixture within said first combustion chamber, said working piston will be forced through a power stroke in order to drive a fastener into a workpiece.

2. The compression engine as set forth in claim 1, wherein:
said power assist mechanism comprises a second combustion chamber.

3. The compression engine as set forth in claim 2, wherein:
said first combustion chamber is defined around a first longitudinal axis L₁; and
said second combustion chamber is defined around a second longitudinal axis L₂.

4. The compression engine as set forth in claim 3, wherein:
said first and second longitudinal axes L₁ and L₂ of said first and second combustion chambers are disposed substantially perpendicular to each other.

5. The compression engine as set forth in claim 4, wherein:
said first and second combustion chambers comprise intake and exhaust ports, the open and closed positions of which are controlled by sleeve valves.

6. The compression engine as set forth in claim 3, wherein:
said first and second longitudinal axes L₁ and L₂ of said first and second combustion chambers are disposed substantially parallel to each other.

7. The compression engine as set forth in claim 6, wherein:
said first and second combustion chambers comprise intake and exhaust valves, the open and closed positions of which are controlled by a valve actuator.

8. The compression engine as set forth in claim 7, wherein:
said compression engine is defined around a central axis L₃;
said intake valve of said first combustion chamber is disposed along said central axis L₃; and
said first and second combustion chambers are disposed upon opposite sides of said central axis L₃ and said intake valve of said first combustion chamber.

9. The compression engine as set forth in claim 1, wherein:
a rotary fan is disposed within said second combustion chamber so as to cause turbulent flow of the air/fuel mixture disposed within said second combustion chamber.

10. The compression engine as set forth in claim 1, wherein:
said power assist mechanism comprises a rack and pinion gear system operatively connected to said working piston for moving said working piston through a return compression stroke so as to enhance the compression of an air/fuel mixture disposed within said first combustion chamber, and the compression ratio of said compression engine, in preparation for the ignition of an air/fuel mixture disposed within said first combustion chamber whereupon ignition of the air/fuel mixture within said first combustion chamber, said working piston will be forced through a power stroke in order to drive a fastener into a workpiece.

11. The compression engine as set forth in claim 8, further comprising:
a pressure actuated servo fluidically connected to said first combustion chamber and operatively connected to said intake and exhaust valves of said first and second combustion chambers so as to maintain said intake and exhaust valves of said first and second combustion chambers in their open positions subsequent to the completion of said power stroke of said working piston so as to permit scavenging of said first and second combustion chambers with fresh air/fuel mixtures.

12. A fastener-driving tool, having a compression engine disposed therein, for driving fasteners into workpieces, comprising:
a working piston;
a first combustion chamber operatively associated with said working piston and containing an air/fuel mixture such that when the air/fuel mixture is ignited within said first combustion chamber, said working piston will be forced through a power stroke in order to drive a fastener into a workpiece; and
a power assist mechanism operatively associated with said working piston for moving said working piston through a return compression stroke so as to enhance the compression of an air/fuel mixture disposed within said first combustion chamber, and the compression ratio of said compression engine, in preparation for the ignition of an air/fuel mixture disposed within said first combustion chamber whereupon ignition of the air/fuel mixture within said first combustion chamber, said working piston will be forced through a power stroke in order to drive a fastener into a workpiece.

13. The fastener-driving tool as set forth in claim 12, wherein:
said power assist mechanism comprises a second combustion chamber.

14. The fastener-driving tool as set forth in claim 13, wherein:
said first combustion chamber is defined around a first longitudinal axis L₁; and
said second combustion chamber is defined around a second longitudinal axis L₂.

15. The fastener-driving tool as set forth in claim 14, wherein:
said first and second longitudinal axes L₁ and L₂ of said first and second combustion chambers are disposed substantially perpendicular to each other.

16. The fastener-driving tool as set forth in claim 15, wherein:
said first and second combustion chambers comprise intake and exhaust ports, the open and closed positions of which are controlled by sleeve valves.

17. The fastener-driving tool as set forth in claim 14, wherein:
said first and second longitudinal axes L₁ and L₂ of said first and second combustion chambers are disposed substantially parallel to each other.

18. The fastener-driving tool as set forth in claim 17, wherein:
said first and second combustion chambers comprise intake and exhaust valves, the open and closed positions of which are controlled by a valve actuator.

19. The fastener-driving tool as set forth in claim 18, wherein:
said compression engine is defined around a central axis L₃;
said intake valve of said first combustion chamber is disposed along said central axis L₃; and
said first and second combustion chambers are disposed upon opposite sides of said central axis L₃ and said intake valve of said first combustion chamber.

20. The fastener-driving tool as set forth in claim 12, wherein:
a rotary fan is disposed within said second combustion chamber so as to cause turbulent flow of the air/fuel mixture disposed within said second combustion chamber.

21. The fastener-driving tool as set forth in claim 12, wherein:
said power assist mechanism comprises a rack and pinion gear system operatively connected to said working piston for moving said working piston through a return compression stroke so as to enhance the compression of an air/fuel mixture disposed within said first combustion chamber, and the compression ratio of said compression engine, in preparation for the ignition of an air/fuel mixture disposed within said first combustion chamber whereupon ignition of the air/fuel mixture within said first combustion chamber, said working piston will be forced through a power stroke in order to drive a fastener into a workpiece.

22. 11. The fastener-driving tool as set forth in claim 18, further comprising:
a pressure actuated servo fluidically connected to said first combustion chamber and operatively connected to said intake and exhaust valves of said first and second combustion chambers so as to maintain said intake and exhaust valves of said first and second combustion chambers in their open positions subsequent to the completion of said power stroke of said working piston so as to permit scavenging of said first and second combustion chambers with fresh air/fuel mixtures.
